(19) United States
(12) Patent Application Publication
(10) Pub. No.: US 2026/0253490 A1
(43) Pub. Date: Aug. 27, 2026

(54) SYSTEM AND METHOD FOR UNIFIED COMMUNICATION PLATFORM THAT ENHANCES TRAFFIC EFFICIENCY AND SAFETY

(71) Applicant: Boost SubscriberCo L.L.C., Englewood, CO (US)

(72) Inventor: Joel Olsson, Centennial, CO (US)

(21) Appl. No.: 19/063,123

(22) Filed: Feb. 25, 2025

(51) Int. Cl. G08G 1/01; B60W 30/09; B60W 30/18; B60W 60/00; G08G 1/16

(52) U.S. Cl. CPC G08G 1/0145; B60W 30/09; B60W 30/18163; B60W 60/0015; G08G 1/166; B60W 2556/45; B60W 2756/10

(57) ABSTRACT

A method for providing coordinated traffic flow management among autonomous vehicles is disclosed. The method includes: providing a decentralized architecture upon which autonomous vehicles from different manufacturers with proprietary APIs and communication systems interact with each other; establishing real-time communication over a cellular network using a network slice that enables the autonomous vehicles to exchange information; leveraging edge computing and low-latency services associated with the network slice to ensure low-latency data transmission between the autonomous vehicles; enabling each autonomous vehicle equipped with a network slice protocol associated with the network slice to continuously share its location, speed, and intended maneuvers; and facilitating dynamic traffic adjustments and collision avoidance based on information shared by the autonomous vehicles using the network slice.

### BACKGROUND

There have been many developments in recent years regarding technology that supports the use and operation of driverless vehicles, also known as autonomous vehicles or self-driving vehicles. However, there are still many technological challenges and continuing disadvantages. Some such technological challenges and continuing disadvantages include security issues, including secure communications. If an autonomous vehicle is hacked or otherwise compromised, this could result in vehicle collisions and/or traffic gridlock. Additionally, while security considerations must be addressed to prevent unauthorized access to autonomous vehicles, this need must be balanced with the competing need for numerous autonomous vehicles (which may likely be from different companies with different communication and security systems) to be able to communicate with each other. This is particularly challenging since modern vehicles, especially autonomous ones, often come equipped with proprietary APIs and communication systems that are not designed to interact seamlessly with those of other manufacturers.

Additionally, traditional traffic management systems rely on centralized control and human driver responses, which can lead to inefficiencies and bottlenecks, especially in complex or high-traffic situations. Furthermore, it is likely that large amounts of data will need to be transmitted between various autonomous vehicles and support systems. Being able to address communication challenges while balancing security concerns is a main technological hurdle that needs to be overcome. It is with respect to these and other considerations that the embodiments described herein have been made.

### BRIEF SUMMARY

The present disclosure relates generally to providing a unified communication platform that enhances traffic efficiency, improves safety through real-time data sharing, and supports secure, scalable vehicle interactions. Briefly stated, one or more methods of providing coordinated traffic flow management among autonomous vehicles are disclosed. Some such methods include: providing a decentralized architecture upon which diverse autonomous vehicles with proprietary APIs and communication systems from different manufacturers interact with each other; establishing real-time communication over a cellular network using a network slice that enables the autonomous vehicles to exchange information; leveraging edge computing and low-latency services associated with the network slice to ensure low-latency data transmission between the autonomous vehicles; enabling each autonomous vehicle equipped with a network slice protocol associated with the network slice to continuously share its location, speed, and intended maneuvers; and facilitating dynamic traffic adjustments and collision avoidance based on information shared by the autonomous vehicles using the network slice.

In other embodiments, a system for providing coordinated traffic flow management among autonomous vehicles is disclosed. The system includes a memory that stores computer-executable instructions and a processor that executes the computer-executable instructions that cause the system to: provide a decentralized architecture upon which diverse autonomous vehicles with proprietary APIs and communication systems from different manufacturers interact with each other; establish real-time communication over a cellular network using a network slice that enables the autonomous vehicles to exchange information; leveraging edge computing and low-latency services associated with the network slice to ensure low-latency data transmission between the autonomous vehicles; enable each autonomous vehicle equipped with a network slice protocol associated with the network slice to continuously share its location, speed, and intended maneuvers; and facilitating dynamic traffic adjustments and collision avoidance based on information shared by the autonomous vehicles using the network slice.

In one or more embodiments of the system and/or method for providing coordinated traffic flow management among autonomous vehicles, the coordinated traffic flow management improves driver safety through real-time data sharing between vehicles and non-vehicle sensor systems. In another aspect of some embodiments, the coordinated traffic flow management enables vehicles to communicate directly and in real-time to facilitate coordinated actions. In still another aspect of some embodiments, the coordinated actions include synchronized lane changes and efficient merging. In yet another aspect of some embodiments, the coordinated traffic flow management enables vehicles to manage dynamic conditions and adapt to sudden changes in driving conditions. Moreover, in another aspect of some embodiments, the sudden changes in driving conditions include an abrupt stop by a leading car or an obstacle appearing on the road.

In one or more embodiments of the system and/or method for providing coordinated traffic flow management among autonomous vehicles, the coordinated traffic flow management enables anticipation of and response to actions of nearby vehicles by performing cooperative maneuvers that include coordinated braking and collaborative route planning. In another aspect of some embodiments, the decentralized architecture of the coordinated traffic flow management is a peer-to-peer (P2P) network model in which each vehicle communicates directly with adjacent vehicles, forming a resilient and scalable mesh network. In still another aspect of some embodiments, the edge computing of the coordinated traffic flow management processes data including position, velocity, and route intentions as low-latency communication for real-time decision-making. In yet another aspect of some embodiments, the coordinated traffic flow management incorporates one or more adaptive data compression algorithms that dynamically adjust compression levels of telemetry data based on network load. Moreover, in another aspect of some embodiments, the coordinated traffic flow management prioritizes transmission of high-importance messages, wherein high-importance messages include one or more of emergency braking signals, emergency lane changes, and emergency route adjustments.

Additionally, another embodiment of a method for providing coordinated traffic flow management among autonomous vehicles is also disclosed. This method includes: establishing real-time communication over a cellular network using a network slice that enables the autonomous vehicles to exchange information; leveraging edge computing and low-latency services associated with the network slice to ensure low-latency data transmission between the autonomous vehicles; enabling each autonomous vehicle equipped with a network slice protocol associated with the network slice to continuously share its location, speed, and intended maneuvers; and facilitating dynamic traffic adjustments and collision avoidance based on information shared by the autonomous vehicles using the network slice.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the disclosed invention, reference will be made to the following Detailed Description, which is to be read in association with the accompanying drawings.

FIG. 1 illustrates a group of autonomous vehicles at a traffic intersection that are managed by a system for coordinated traffic flow management among autonomous vehicles.

FIG. 2 illustrates a context diagram of an environment in which a system for coordinated traffic flow management among autonomous vehicles may be implemented in accordance with embodiments described herein.

FIG. 3 illustrates a diagram showing connectivity between an autonomous vehicle and certain telecommunication network components during cellular telecommunication.

FIG. 4A illustrates a diagram showing communication flow between autonomous vehicles, an autonomous vehicle and a network, and an autonomous vehicle and traffic control infrastructure, in an embodiment of the system for coordinated traffic flow management among autonomous vehicles.

FIG. 4B illustrates a diagram showing communication flow between an autonomous vehicles, an autonomous vehicle and a cellular network, an autonomous vehicle and a home network, an autonomous vehicle and a cloud network, and an autonomous vehicle and traffic control infrastructure, in another embodiment of the system for coordinated traffic flow management among autonomous vehicles.

FIG. 5A illustrates a diagram showing communication flow between autonomous vehicles, a cellular network, and a cloud network, in still another embodiment of the system for coordinated traffic flow management among autonomous vehicles.

FIG. 5B illustrates a diagram showing communication flow between autonomous vehicles, traffic control infrastructure, an edge server, and a cloud network, in yet another embodiment of the system for coordinated traffic flow management among autonomous vehicles.

FIG. 6 is a logic diagram showing a method for coordinated traffic flow management among autonomous vehicles.

FIG. 7 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments of a system for coordinated traffic flow management among autonomous vehicles. However, one skilled in the relevant art will recognize that the disclosed embodiments may be practiced in various combinations, without one or more of these specific details, or with other methods, components, devices, materials, and the like. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Advanced cellular networks provide a broad range of wireless services delivered to the end user across multiple access platforms and multi-layer networks. For example, 5G is a dynamic, coherent and flexible framework of multiple advanced technologies supporting a variety of applications, such as a system for coordinated traffic flow management among autonomous vehicles. 5G utilizes an intelligent architecture, with Radio Access Networks (RANs) not constrained by base station proximity or complex infrastructure. 5G enables a disaggregated, flexible, and virtual RAN with interfaces creating additional data access points. 5G network functions may be completely software-based and designed as cloud-native, meaning that they're agnostic to the underlying cloud infrastructure, allowing higher deployment agility and flexibility. With the advent of 5G, industry experts defined how the 5G Core (5GC) network should evolve to support the needs of 5G New Radio (NR) and the advanced use cases enabled by it. The 3rd Generation Partnership Project (3GPP) develops protocols and standards for telecommunication technologies including RAN, core transport networks and service capabilities. 3GPP has provided complete system specifications for 5G network architecture which is much more service oriented than previous generations. Future network architectures, such as 6G and others, are expected to utilize many of these features and functionalities.

Multi-Access Edge Computing (MEC) is an important element of 5G architecture. MEC is an evolution in telecommunications that brings the applications from centralized data centers to the network edge, and therefore closer to the end users and their devices. This essentially creates a shortcut in content delivery between the user and host, and the long network path that once separated them. This MEC technology is not exclusive to 5G but is certainly important to its efficiency. Characteristics of the MEC include the low latency, high bandwidth and real time access to RAN information that distinguishes 5G architecture from its predecessors. This convergence of the RAN and core networks enables operators to leverage new approaches to network testing and validation. 5G networks based on the 3GPP 5G specifications provide an environment for MEC deployment. The 5G specifications define the enablers for edge computing, allowing MEC and 5G to collaboratively route traffic. In addition to the latency and bandwidth benefits of the MEC architecture, the distribution of computing power better enables the high volume of connected devices (e.g., AVs) inherent to 5G deployment and the rise of IoT, as well as a system for coordinated traffic flow management among autonomous vehicles.

The 5G architecture is based on what is called a Service-Based Architecture (SBA), which leverages IT development principles and a cloud-native design approach. In this architecture, each network function (NF) offers one or more services to other NFs via Application Programming Interfaces (API). Network function virtualization (NFV) decouples software from hardware by replacing various network functions such as firewalls, load balancers and routers with virtualized instances running as software.

NFV enables the 5G infrastructure by virtualizing appliances within the 5G network. This includes the network slicing technology that enables multiple virtual networks to run simultaneously, and which may be used to support a system for coordinated traffic flow management among autonomous vehicles. NFV may address other 5G challenges through virtualized computing, storage, and network resources that are customized based on the applications and customer segments. The concept of NFV extends to the RAN through, for example, network disaggregation promoted by alliances such as O-RAN. This enables flexibility, provides open interfaces and open-source development, ultimately to ease the deployment of new features and technology with scale. The O-RAN ALLIANCE objective is to allow multi-vendor deployment with off-the-shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for IoT applications where the number of devices is in the millions.

The 5G New Radio (5G NR) RAN comprises a set of radio base stations (each known as Next Generation Node B (gNB)) connected to the 5G Core (5GC) and to each other. The gNB incorporates three main functional modules: the Centralized Unit (CU), the distributed Unit (DU), and the Radio Unit (RU), which can be deployed in multiple combinations. The primary interface is referred to as the F1 interface between DU and CU and is interoperable across vendors. The CU may be further disaggregated into the CU user plane (CU-UP) and CU control plane (CU-CP), both of which connect to the DU over F1-U and F1-C interfaces, respectively. This 5G RAN architecture is described in 3GPP TS 38.401 V16.8.0 (2021-12). Each network function (NF) is formed by a combination of small pieces of software code called microservices. Future network architectures, such as 6G and others, are expected to utilize many of these technological improvements, plus additional advancements.

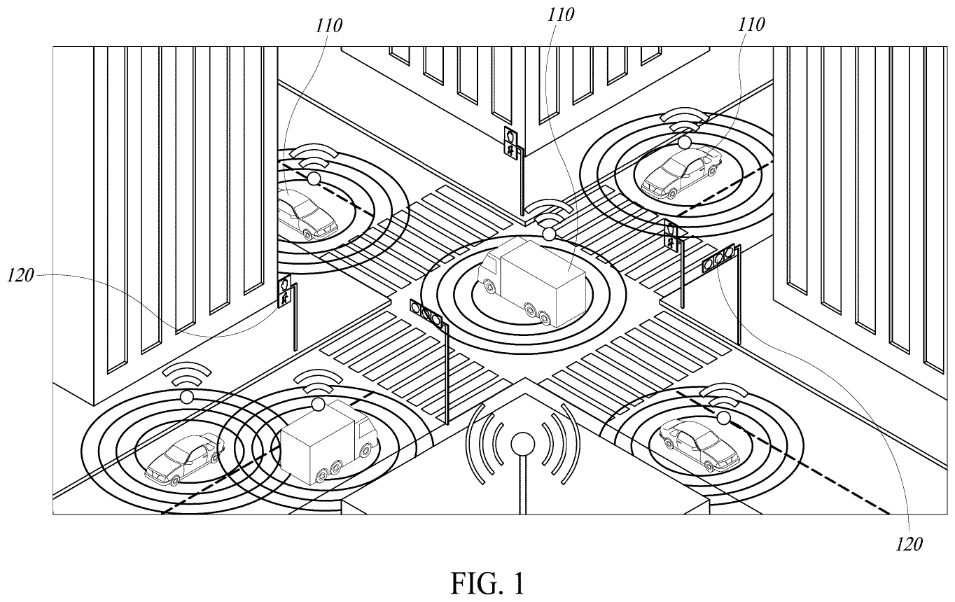

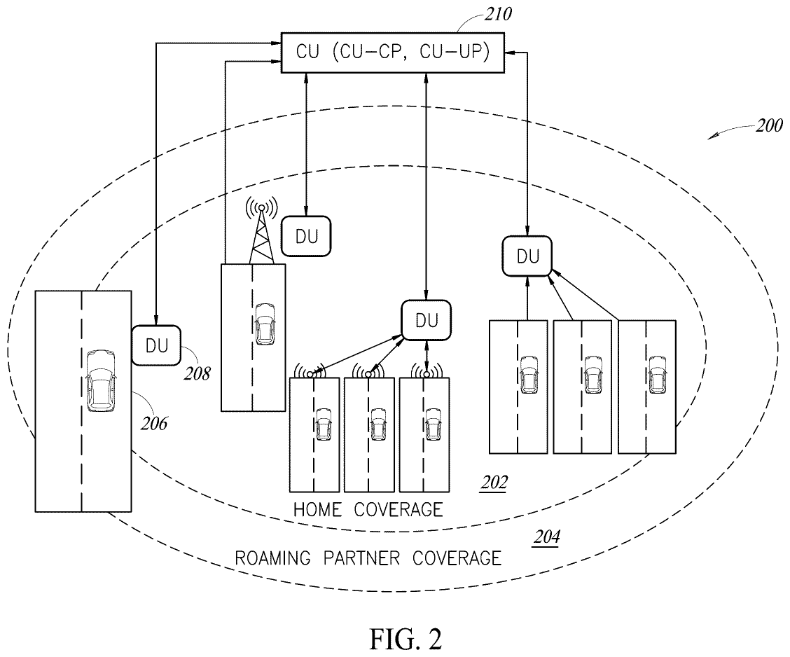

Referring now to FIG. 1, a group of autonomous vehicles 110 are shown that are managed by a system for coordinated traffic flow management among autonomous vehicles. Specifically, the group of autonomous vehicles 110 are shown navigating a traffic intersection using their communications and coordinated traffic flow management. The group of autonomous vehicles 110 communicate with each other, with the traffic control infrastructure 120, and with a cellular network (shown in FIG. 2) using the system for coordinated traffic flow management among autonomous vehicles.

FIG. 2 illustrates a context diagram of an environment in which a system for coordinated traffic flow management among autonomous vehicles may be implemented in accordance with embodiments described herein. A given area 200 will mostly be covered by two or more wireless networks. Generally, mobile network operators have some roaming agreements that allow users to roam from home network to partner network under certain conditions, shown in FIG. 2 as home coverage area 202 and roaming partner coverage area 204. Operators may configure the user's device, referred to herein as driverless autonomous vehicle (AV), such as AV 206, with priority and a designated roaming partner network that is used in the roaming partner network coverage area 204. If an AV (e.g., AV 206) cannot find the home network coverage area 202, the AV will be transferred to a partner roaming network in the roaming partner coverage area 204. Thus, service coverage is maintained even if the home coverage area 202 is providing unsatisfactory service coverage.

As shown in FIG. 2, a 5G RAN is split into DUs (e.g., DU 208) that manage scheduling of all the users and a CU (CU-CP, CU-UP) 210 that manages the mobility and radio resource control (RRC) state for all the AVs 206. The RRC is a layer within the 5G NR protocol stack. It exists only in the control plane, in the AV 206 and in the gNB. The behavior and functions of RRC are governed by the current state of RRC. In 5G NR, RRC has three distinct states: RRC_IDLE, RRC_CONNECTED and RRC_INACTIVE.

In some embodiments of the system for coordinated traffic flow management among autonomous vehicles, a radio unit (RU) converts radio signals sent to and from the antenna into a digital signal for transmission over packet networks. It handles the digital front end (DFE) and the lower physical (PHY) layer, as well as the digital beamforming functionality. The DU may sit close to the RU and runs the radio link control (RLC), the Medium Access Control (MAC) sublayer of the 5G NR protocol stack, and parts of the PHY layer. The MAC sublayer interfaces to the RLC sublayer from above and to the PHY layer from below. The MAC sublayer maps information between logical and transport channels.

The CU is the centralized unit that runs the RRC and Packet Data Convergence Protocol (PDCP) layers. A gNB may comprise a CU and one DU connected to the CU via Fs-C and Fs-U interfaces for control plane (CP) and user plane (UP), respectively. A CU with multiple DUs will support multiple gNBs. The split architecture enables a 5G network to utilize different distribution of protocol stacks between CU and DU depending on mid-haul availability and network design. The CU is a logical node that includes the gNB functions like transfer of user data, mobility control, RAN sharing, positioning, session management, etc., with the exception of functions that may be allocated exclusively to the DU. The CU controls the operation of several DUs over the mid-haul interface. 5G network functionality is split into two functional units: the DU, which is responsible for real time 5G layer 1 (L1) and 5G layer 2 (L2) scheduling functions, as well as many aspects of the system for coordinated traffic flow management among autonomous vehicles, and the CU, which is responsible for non-real time, higher L2 and 5G layer 3 (L3).

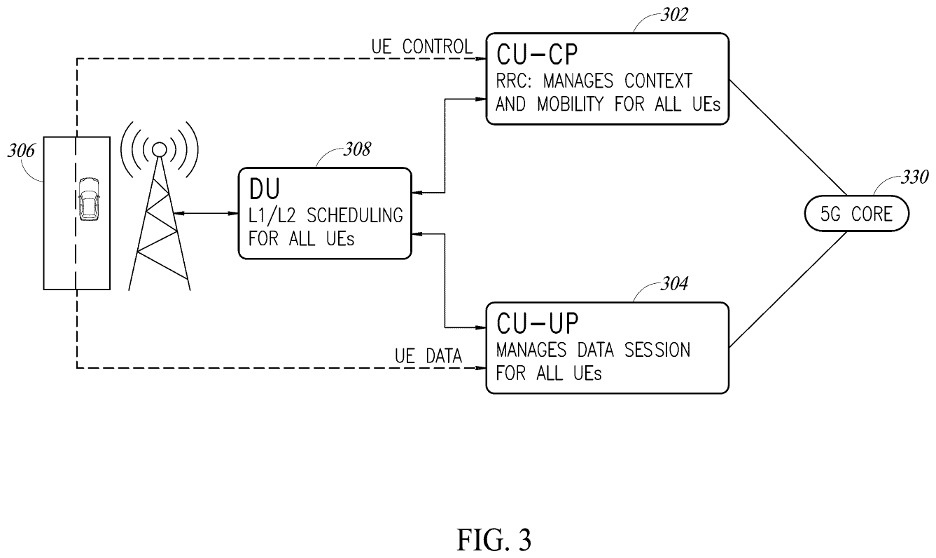

FIG. 3 is a diagram showing connectivity between an autonomous vehicle and certain telecommunication network components (e.g., CU, DU, 5G Core) during cellular telecommunication in accordance with embodiments described herein for the system for coordinated traffic flow management among autonomous vehicles. Referring still to FIG. 3, the central unit control plane (CU-CP) 302, primarily manages control processing of DUs, such as DU 308, and AVs, such as AV 306. The CU-CP 302 hosts RRC and the control-plane part of the PDCP protocol. CU-CP 302 manages the mobility and radio resource control (RRC) state for all the AVs 306. The RRC is a layer within the 5G NR protocol stack and manages context and mobility for all AVs 306. The behavior and functions of RRC are governed by the current state of RRC. In 5G NR, RRC has three distinct states: RRC_IDLE, RRC_CONNECTED and RRC_INACTIVE. The CU-CP 302 terminates the E1 interface connected with the central unit user plane (CU-UP) 304 and the F1-C interface connected with the DU 308. The DU 308 maintains a constant heartbeat with CU-CP 302. The CU-UP 304 manages the data sessions for all AVs 306 and hosts the user plane part of the PDCP protocol. The CU-UP 304 terminates the E1 interface connected with the CU-CP and the F1-U interface connected with the DU 308. Additionally, the CU-CP 302 and the CU-UP 304 further each connect to the 5G Core 330.

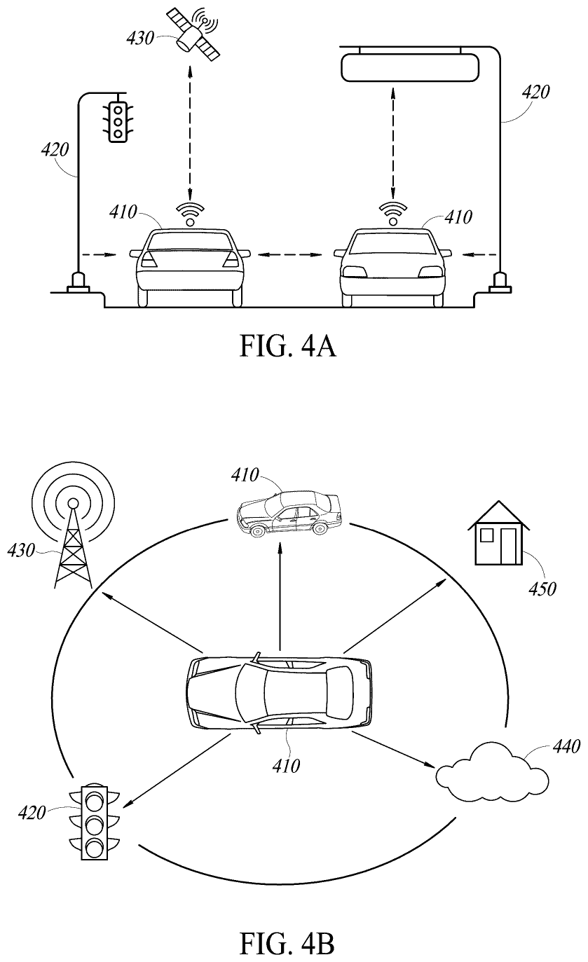

Referring now to FIGS. 4A and 4B, in some embodiments, the system for coordinated traffic flow management among autonomous vehicles provides security and traffic flow services to AVs 410 across multiple networks. In FIG. 4A, autonomous vehicles 410 communicate with each other, with the non-vehicle sensors systems (e.g., traffic control infrastructure 420), and with a cellular network 430 using the system for coordinated traffic flow management among autonomous vehicles. In FIG. 4B, autonomous vehicles 410 communicate with each other, with the traffic control infrastructure 420, with the cellular network 430, with a cloud network 440, and with a home network 450. Specifically, in one or more embodiments, the autonomous vehicles 410 communicate with each other and the cellular network 430 by implementing a global network slice protocol across the autonomous vehicle communication platform. Network slicing is a network architecture that enables the multiplexing of virtualized and logical networks on the same physical network infrastructure. Each network slice is an isolated end-to-end network that is designed to provide specific requirements that are needed by a particular user or application.

In slice identity management, individual network slices may be formed by an identifier called Single-Network Slice Selection Assistance Information (S-NSSAI). This slice identifier (ID) is required to achieve end-to-end network slicing. The identifier enables a customer to carry S-NSSAI on User Equipment, RAN, and the Core Network to identify a specific network slice. In some embodiments, there are different slice service types (SST: Slice and Service Type) for different network slices. These slice service types include, by way of example only, and not by way of limitation: eMBB (high speed/large capacity), mIoT (multi-connection, power saving, low cost), and URLLC (low latency, high reliability). The individual network slices identifier is used to identify a network slice across a 5G Core, a 5G-RAN, and the Driverless Autonomous Vehicle (AV).

In one embodiment of a system for coordinated traffic flow management among autonomous vehicles, a network slice is accessed for each AV 410 that is communicating in the system. Each network slice is used to identify and route traffic for an AV 410 (e.g., in support of collaborative route planning) to a specific network service. The network slice can also be accessed by other AVs 410 on the communication platform. In one embodiment, the system for coordinated traffic flow management among autonomous vehicles uses network slice IDs to enable routing to the network slice (and equivalent slice functionality) for the network service by each of the AVs 410 on the network. In this manner, the system for coordinated traffic flow management among autonomous vehicles creates a slice overlay network that provides each AV 410 with the desired network service, such as security, encryption, and coordinated traffic flow management (SST: Slice and Service Type).

Additionally, in some embodiments of the system for coordinated traffic flow management among autonomous vehicles, information connecting an AV 410 to its home network slice (and associated functionality) is routed using network slice IDs between multiple telecommunication networks without using public internet. For example, in one embodiment a first autonomous vehicle 410 and associated telemetry service infrastructure 420 is hosted by a host network from among multiple telecommunication networks. In such an embodiment, the host network enables other AVs 410 on the host network (and on the multiple other telecommunication networks) to access the network slice ID of the first autonomous vehicle 410, and thereby communicate with the first autonomous vehicle 410. In some embodiments, the specific network services that are accessed by the AVs 410 using the network slice include one or more of a security service, a low latency service, a high availability service, a data analytics service, a threat detection service, and an autonomous vehicle telemetry service.

In some embodiments of the system for coordinated traffic flow management among autonomous vehicles, security data centers are stored in the network slices. These security data centers include security functions such as firewall services, threat detection services, and zero trust services. By using the system for coordinated traffic flow management among autonomous vehicles, AVs 410 are routed to their network slice and associated services, no matter where those AVs 410 are roaming (i.e., out of their home network), without the AVs 410 having to interact with the Internet, which could result in many unnecessary security concerns. In another aspect of the system for coordinated traffic flow management among autonomous vehicles that involves autonomous vehicle management, an autonomous vehicle 410 is able to travel over wide geographical areas, and no matter where the autonomous vehicle 410 travels, the autonomous vehicle 410 is ensured to have its vehicle information (e.g., telemetry information, etc.) routed back via a secure connection to its home data center using the network slice protocol.

In one or more embodiments of the system for coordinated traffic flow management among autonomous vehicles, AVs 410 are routed through 5G network slices, and not the unsecure public internet. Thus, this system for coordinated traffic flow management among autonomous vehicles makes the default network transmission medium a 5G network slice, rather than the Internet. Therefore, when an AV 410 connects to the 5G network, they are immediately routed to a 5G security center where they are provided with all of the appropriately configured 5G service functionality (e.g., security, encryption, autonomous vehicle telemetry service, etc.). The 5G security center, which is native to the 5G network, orchestrates the 5G functionality, e.g., geographical restrictions, security, encryption, low latency, etc., which is associated with that 5G network slice. This enables native 5G functionality like autonomous vehicle management, encryption, telemetry information, and the like, to be provided automatically to the AV 410 (without requiring clumsy “bolted on” services).

Since these AVs 410 are being routed over a 5G network slice (rather than the unsecure Internet), AV profile security can be used that is native to the 5G network protocol. In this manner, only AV traffic that is using the trusted network slice protocol can access the 5G network slice. This prevents malicious attacks from users or systems that are transmitting data that is not AV traffic from the 5G network slice, and since any non-AV traffic is not using the trusted network slice protocol.

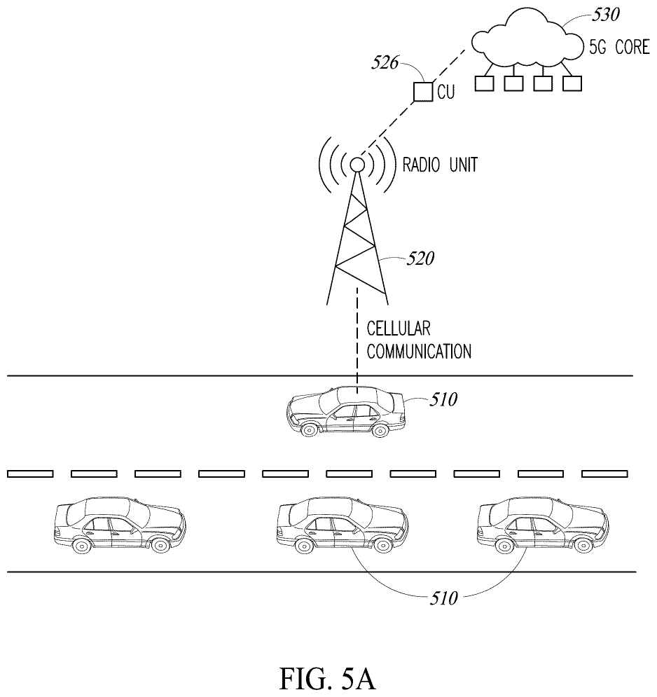

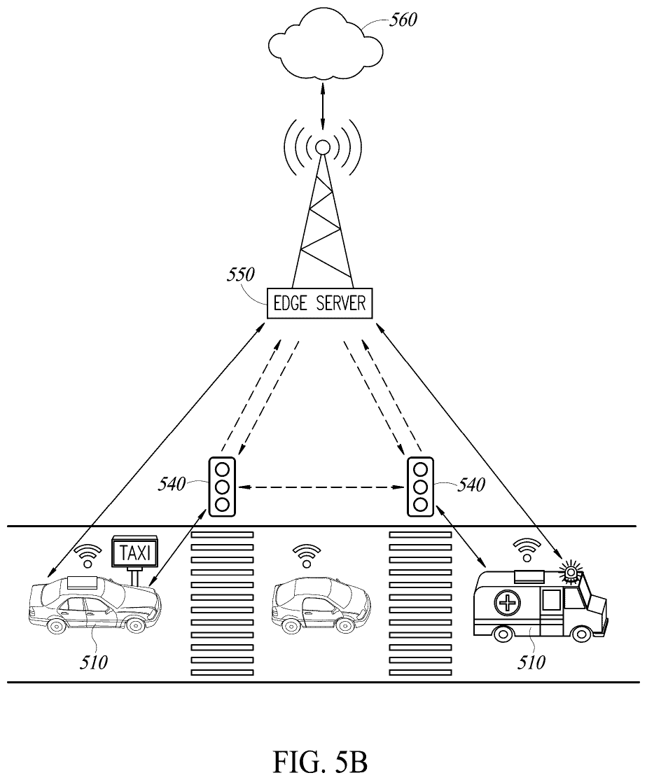

Referring now to FIG. 5A, the system for coordinated traffic flow management among autonomous vehicles solves the technological problem of interoperability among diverse autonomous vehicle systems by providing a unified communication platform, which is accessible via 5G network slice protocols, to facilitate the exchange of essential autonomous vehicle information to efficiently manage and coordinate traffic flow among autonomous vehicles. Significantly, the system for coordinated traffic flow management among autonomous vehicles enhances traffic efficiency, improves safety through real-time data sharing, and supports secure, scalable vehicle interactions. This system enables seamless coordination and adaptive responses among autonomous vehicles, reducing congestion, and optimizing road use. In the embodiment shown in FIG. 5A, autonomous vehicles 510 communicate with each other and with a Radio Unit 520 (RU) of a cellular network, as well as a 5G Core 530 via a CU 526, using the system for coordinated traffic flow management among autonomous vehicles.

This is particularly challenging since autonomous vehicles typically come equipped with proprietary APIs and communication systems that are not designed to interact seamlessly with those of other manufacturers. The system for coordinated traffic flow management among autonomous vehicles addresses this issue by providing a standardized platform, which is accessible via 5G network slice protocols, to integrate with a wide range of vehicle APIs, enabling smooth data exchange regardless of the autonomous vehicle's make or model.

In the embodiment shown in FIG. 5B, autonomous vehicles 510 communicate with each other, with non-vehicle sensors systems (e.g., traffic control infrastructure 540), and with an edge server 550, as well as the cloud server 560, using the system for coordinated traffic flow management among autonomous vehicles. The system for coordinated traffic flow management among autonomous vehicles utilizes a 5G network slice protocol that addresses the need for efficient and coordinated traffic flow management among autonomous vehicles. This 5G network slice protocol establishes robust, secure, real-time network communication that enables autonomous cars to seamlessly exchange vital information. The system for coordinated traffic flow management among autonomous vehicles leverages edge computing (provided by the edge server 550) and low-latency services associated with the network slice to ensure low-latency data transmission between autonomous vehicles. Each autonomous vehicle 510 that is equipped with the 5G network slice protocol continuously shares its location, speed, and intended maneuvers, thereby enabling dynamic traffic adjustments and collision avoidance based on information shared by the autonomous vehicles using the network slice.

Referring now to various aspects of the system for coordinated traffic flow management among autonomous vehicles, in some embodiments, the system employs a peer-to-peer (P2P) network architecture in which each autonomous vehicle 510 is able to communicate directly with adjacent autonomous vehicles 510, thereby forming a resilient and scalable mesh network of autonomous vehicles 510. This decentralized architecture reduces the need for a central server and the risk of single points of failure, while improving overall system reliability. Additionally, low-latency transmissions are enhanced since the peer-to-peer communications between adjacent autonomous vehicles have a dramatically shorter distant to travel. Such communications between adjacent autonomous vehicles 510 are common and critical, in order to manage situations of collision avoidance and coordination of intended maneuvers between adjacent autonomous vehicles 510.

Accordingly, the system for coordinated traffic flow management among autonomous vehicles enables autonomous vehicles 510 to communicate directly with each other and in real-time, which facilitates coordinated actions like synchronized lane changes and efficient merging. This in turn results in more fluid traffic flow and reduces congestion. Without real-time communication, autonomous vehicles 510 cannot quickly adapt to sudden changes in driving conditions, such as an abrupt stop by a leading vehicle or an obstacle appearing on the road. Thus, the system for coordinated traffic flow management among autonomous vehicles ensures that autonomous vehicles 510 can instantly share and react to such critical data, which enhances their ability to manage dynamic conditions effectively and improves overall safety.

In one or more embodiments of the system for coordinated traffic flow management among autonomous vehicles, the system employs a peer-to-peer (P2P) network architecture in addition to a centralized network (instead of substituting for a centralized network). This system architecture with both a centralized network and a peer-to-peer (P2P) network architecture enables the system to leverage the benefits of both network architectures simultaneously. In another aspect of the system for coordinated traffic flow management among autonomous vehicles, the system employs an edge server 550, as well as the peer-to-peer (P2P) network architecture and the centralized network (e.g., cloud server 530).

Accordingly, some embodiments of the system for coordinated traffic flow management among autonomous vehicles utilize edge computing (provided by the edge server 550) and low-latency services associated with network slice protocol to ensure low-latency data transmission between autonomous vehicles. The network slice protocol ensures that critical data (e.g., telemetry data), such as position, velocity, and route intentions are processed and shared with minimal delay. This low-latency communication is crucial for real-time decision-making, particularly in high-density traffic environments. This low-latency communication may also be used in support of collaborative route planning.

In some embodiments, the system for coordinated traffic flow management among autonomous vehicles optimizes bandwidth usage by incorporating one or more adaptive data compression algorithms that dynamically adjust the level of compression of the telemetry data (or other critical data) based on network load. For example, there is minimal or no compression during times of low network load, but there is a high degree of compression during times of high network load. Additionally, the system for coordinated traffic flow management among autonomous vehicles prioritizes the transmission of high-importance messages, such as emergency braking signals that may be used to support coordinated braking. This prioritization ensures that these high-importance messages are delivered promptly even under heavy network traffic conditions.

In another aspect of the system for coordinated traffic flow management among autonomous vehicles, the 5G network slice protocol that is implemented promotes fundamental network and communication security. As described above, since autonomous vehicles 510 are being routed over a 5G network slice, autonomous vehicles profile security is implemented that is native to the 5G network protocol. In this manner, only autonomous vehicle traffic that is of a trusted protocol can access the 5G network slice. This prevents malicious attacks from users or systems that are transmitting data that is not AV traffic from the 5G network slice, and thus, the data is not a trusted network slice protocol. The network slice protocol utilizes end-to-end encryption and digital signatures to protect data integrity and prevent unauthorized access.

Each autonomous vehicle's identity is authenticated through a public key infrastructure (PKI), ensuring that only trusted devices can participate in the network slice. Additionally, the network slice protocol of the system for coordinated traffic flow management among autonomous vehicles incorporates robust encryption and authentication protocols that ensure secure and trusted communications between vehicles 510. In this manner, the system protects against unauthorized data access and maintains the privacy of autonomous vehicle interactions.

Referring now to another aspect of the system for coordinated traffic flow management among autonomous vehicles, in some embodiments, the 5G network slice protocol enables autonomous vehicles 510 to collaborate directed with each other on traffic management strategies. For example, in one implementation, multiple autonomous vehicles 510 that are all approaching an intersection at the same time can negotiate priority, optimizing traffic flow, and reduce wait times. In another implementation that addresses the situation of incidents or sudden stops, the system for coordinated traffic flow management among autonomous vehicles facilitates immediate notification to surrounding autonomous vehicles 510, which enables them to adjust their routes or speeds accordingly.

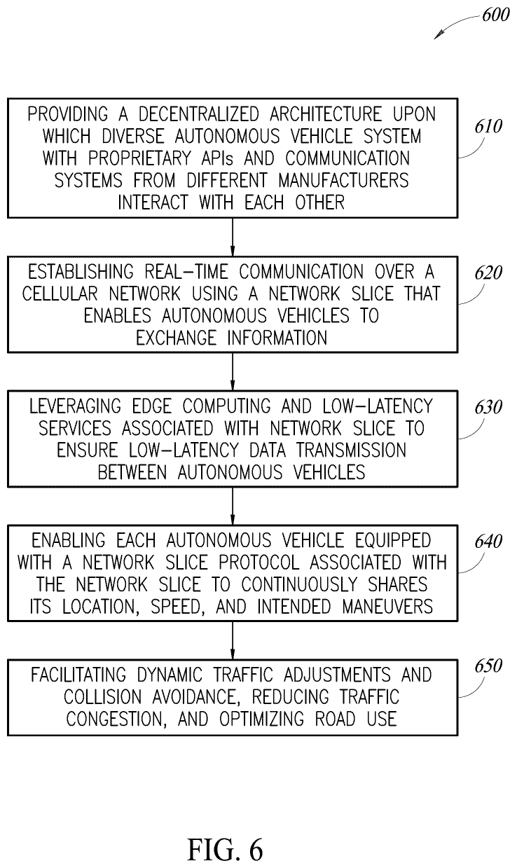

FIG. 6 is a logic diagram showing a method 600 for providing coordinated traffic flow management among autonomous vehicles. This schedule method may be implemented as a 5G architecture, such as has been shown in FIGS. 1-5 as described above. As shown in FIG. 6, at operation 610, the method includes providing a decentralized architecture upon which diverse autonomous vehicle systems with proprietary APIs and communication systems from different manufacturers interact with each other. At operation 620, the method includes establishing real-time communication over a cellular network using a network slice that enables autonomous vehicles to exchange information. At operation 630, the method includes leveraging edge computing and low-latency services associated with network slice to ensure low-latency data transmission between autonomous vehicles. At operation 640, the method includes enabling each autonomous vehicle equipped with a network slice protocol associated with the network slice to continuously share its location, speed, and intended maneuvers. At operation 650, the method includes facilitating dynamic traffic adjustments and collision avoidance, reducing traffic congestion, and optimizing road use.

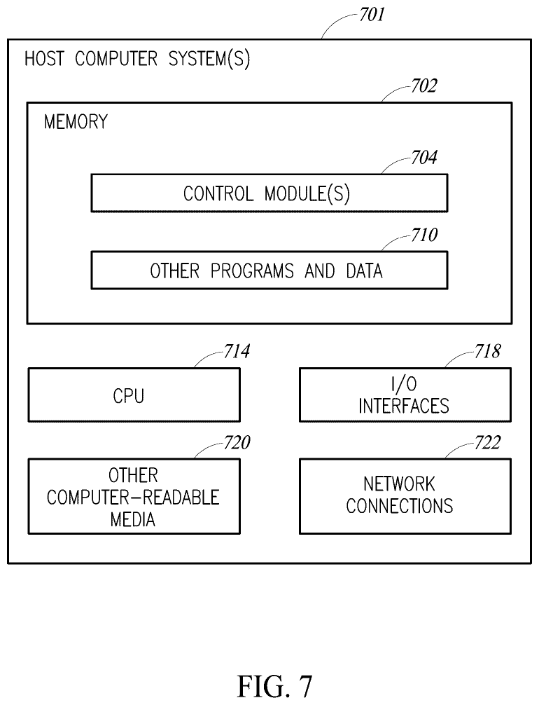

FIG. 7 shows a system diagram that describes an example implementation of a computing system(s) for implementing embodiments described herein. The functionality described herein for a system for coordinated traffic flow management among autonomous vehicles can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. This system may be implemented as a 5G architecture, such as has been shown in FIGS. 1-3 as described above.

In particular, shown is example host computer system(s) 701. For example, such computer system(s) 701 may represent those in various data centers and gNBs shown and/or described herein that host the functions, components, microservices and other aspects described herein to implement a method for providing equivalent services to user devices across multiple participating telecommunication networks. In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more central processing units (CPUs) 714, I/O interfaces 718, other computer-readable media 720, and network connections 722.

Memory 702 may include one or more various types of non-volatile and/or volatile storage technologies. Examples of memory 702 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 702 may be utilized to store information, including computer-readable instructions that are utilized by CPU 714 to perform actions, including those of embodiments described herein.

Memory 702 may have stored thereon control module(s) 704. The control module(s) 704 may be configured to implement and/or perform some or all of the functions of the systems, components and modules described herein for a method for providing equivalent services to user devices across multiple participating telecommunication networks. Memory 702 may also store other programs and data 710, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, and the like.

Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 718 may include a video interface, other data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for providing coordinated traffic flow management among autonomous vehicles, the method comprising:
providing a decentralized architecture upon which autonomous vehicles from different manufacturers with proprietary APIs and communication systems interact with each other;
establishing real-time communication over a cellular network using a network slice that enables the autonomous vehicles to exchange information;
leveraging edge computing and low-latency services associated with the network slice to ensure low-latency data transmission between the autonomous vehicles;
enabling each autonomous vehicle equipped with a network slice protocol associated with the network slice to continuously share its location, speed, and intended maneuvers; and
facilitating dynamic traffic adjustments and collision avoidance based on information shared by the autonomous vehicles using the network slice.

2. The method of claim 1, wherein the coordinated traffic flow management facilitates real-time data sharing between vehicles and non-vehicle sensor systems.

3. The method of claim 1, wherein the coordinated traffic flow management enables vehicles to communicate directly and in real-time to facilitate coordinated actions.

4. The method of claim 3, wherein the coordinated actions include synchronized lane changes and efficient merging.

5. The method of claim 1, wherein the coordinated traffic flow management enables vehicles to manage dynamic conditions and adapt to sudden changes in driving conditions.

6. The method of claim 5, wherein the sudden changes in driving conditions include an abrupt stop by a leading car or an obstacle appearing on a road.

7. The method of claim 1, wherein the coordinated traffic flow management enables anticipation of and response to actions of nearby vehicles by performing cooperative maneuvers that include coordinated braking and collaborative route planning.

8. The method of claim 1, wherein the decentralized architecture of the coordinated traffic flow management is a peer-to-peer (P2P) network model in which each vehicle communicates directly with adjacent vehicles, forming a resilient and scalable mesh network.

9. The method of claim 1, wherein the edge computing of the coordinated traffic flow management processes data including position, velocity, and route intentions as low-latency communication for real-time decision-making.

10. The method of claim 1, wherein the coordinated traffic flow management incorporates one or more adaptive data compression algorithms that dynamically adjust compression levels of telemetry data based on network load.

11. The method of claim 1, wherein the coordinated traffic flow management prioritizes transmission of high-importance messages, wherein high-importance messages include one or more of emergency braking signals, emergency lane changes, and emergency route adjustments.

12. A system for providing coordinated traffic flow management among autonomous vehicles, the system comprising:
a memory that stores computer-executable instructions; and
a processor that executes the computer-executable instructions and causes the system to:
provide a decentralized architecture upon which autonomous vehicles from different manufacturers with proprietary APIs and communication systems interact with each other;
establish real-time communication over a cellular network using a network slice that enables the autonomous vehicles to exchange information;
leverage edge computing and low-latency services associated with the network slice to ensure low-latency data transmission between the autonomous vehicles;
enable each autonomous vehicle equipped with a network slice protocol associated with the network slice to continuously share its location, speed, and intended maneuvers; and
facilitate dynamic traffic adjustments and collision avoidance based on information shared by the autonomous vehicles using the network slice.

13. The system of claim 12, wherein the coordinated traffic flow management enables vehicles to communicate directly and in real-time to facilitate coordinated actions that include synchronized lane changes and efficient merging.

14. The system of claim 12, wherein the coordinated traffic flow management enables vehicles to manage dynamic conditions and adapt to sudden changes in driving conditions.

15. The system of claim 12, wherein the coordinated traffic flow management enables anticipation of and response to actions of nearby vehicles by performing cooperative maneuvers that include coordinated braking and collaborative route planning.

16. The system of claim 12, wherein the decentralized architecture of the coordinated traffic flow management is a peer-to-peer (P2P) network model in which each vehicle communicates directly with adjacent vehicles, forming a resilient and scalable mesh network.

17. The system of claim 12, wherein the edge computing of the coordinated traffic flow management processes data including position, velocity, and route intentions as low-latency communication for real-time decision-making.

18. The system of claim 12, wherein the coordinated traffic flow management incorporates one or more adaptive data compression algorithms that dynamically adjust compression levels of telemetry data based on network load.

19. The system of claim 12, wherein the coordinated traffic flow management prioritizes transmission of high-importance messages, wherein high-importance messages include one or more of emergency braking signals, emergency lane changes, and emergency route adjustments.

20. A method for providing coordinated traffic flow management among autonomous vehicles, the method comprising:
establishing real-time communication over a cellular network using a network slice that enables the autonomous vehicles to exchange information;
leveraging edge computing and low-latency services associated with the network slice to ensure low-latency data transmission between the autonomous vehicles;
enabling each autonomous vehicle equipped with a network slice protocol associated with the network slice to continuously share its location, speed, and intended maneuvers; and
facilitating dynamic traffic adjustments and collision avoidance based on information shared by the autonomous vehicles using the network slice.
